(19) United States
(12) Patent Application Publication
(10) Pub. No.: US 2011/0026809 A1
(43) Pub. Date: Feb. 3, 2011

(54) Fast multi-view three-dimensional image synthesis apparatus and method

(75) Inventors: Hong Jeong, Gyeongsangbuk-do (KR); Jang Myoung Kim, Seoul (KR); Sung Chan Park, Kyungsangbuk-do (KR)

Correspondence Address: BACON & THOMAS, PLLC, 625 SLATERS LANE, FOURTH FLOOR, ALEXANDRIA, VA, 22314-1176, US

(73) Assignee: POSTECH Academy-Industry Foundation, Gyeongsangbuk-do (KR)

(21) Appl. No.: 12/923,820

(22) Filed: Oct. 8, 2010

Related U.S. Application Data
(63) Continuation of application No. PCT/KR2009/001834, filed on Apr. 9, 2009.

(30) Foreign Application Priority Data
Apr. 10, 2008 (KR) 10-2008-0033176

(51) Int. Cl. G06K 9/00

(52) U.S. Cl. 382/154

(57) ABSTRACT

A fast multi-view three-dimensional image synthesis apparatus includes: a disparity map generation module for generating a left image disparity map by using left and right image pixel data; intermediate-view generation modules for generating intermediate-view pixel data from different view points by using the left and right image pixel data and the left image disparity map; and a multi-view three-dimensional image generation module for generating multi-view three-dimensional image pixel data by using the left image pixel data, the right image pixel data and intermediate-view pixel data. Each of the intermediate-view generation module includes: a right image disparity map generation unit for generating a rough right image disparity map; an occluded region compensation unit for generating a right image disparity map by removing occluded regions from the rough right image disparity map; and an intermediate-view generation unit for generating the intermediate-view pixel data from the different view points.

This application is a Continuation Application of PCT International Application No. PCT/KR2009/001834 filed on 9 Apr. 2009, which designated the United States.

### FIELD OF THE INVENTION

The present invention relates to a fast multi-view 3D (three-dimensional) image synthesis apparatus and method; and, more particularly, to a fast multi-view 3D image synthesis apparatus and method using a disparity map for, e.g., autostereoscopic 3D TV (television) displays.

### BACKGROUND OF THE INVENTION

Stereo image matching is a technique for re-creating 3D spatial information from a pair of 2D (two-dimensional) images.

FIG. 1 illustrates an explanatory view of stereo image matching. First found in the stereo image matching are left and right pixels 10 and 11, corresponding to an identical point (X,Y,Z) in a 3D space, on image lines on a left image epipolar line and a right image epipolar line, respectively. Next, a disparity for a conjugate pixel pair, i.e., the left and right pixels, is obtained. Referring to FIG. 1, a disparity d is defined as d=x^{l}−x^{r}. The disparity has distance information, and a geometrical distance calculated from the disparity is referred to as a depth.

A disparity map is a set of disparities obtained by the stereo image matching. From the disparity map of an input image, 3D distance and shape information on an observation space can be measured. Hence, the disparity map is used in a multiple image synthesis, which is necessary for the autostereoscopic 3D TV displays.

However, the image synthesis speed and the quality of a synthesized image are still remained to be improved.

### SUMMARY OF THE INVENTION

In view of the above, the present invention provides a fast multi-view 3D image synthesis apparatus and method using a disparity map for, e.g., autostereoscopic 3D TV displays.

In accordance with an aspect of the present invention, there is provided a fast multi-view three-dimensional image synthesis apparatus, including:

a disparity map generation module for generating a left image disparity map by using left and right image pixel data;

intermediate-view generation modules for generating intermediate-view pixel data from different view points by using the left and right image pixel data and the left image disparity map; and

a multi-view three-dimensional image generation module for generating multi-view three-dimensional image pixel data by using the left image pixel data, the right image pixel data and intermediate-view pixel data.

Preferably, the left and right image pixel data are on an identical epipolar line.

Preferably, the disparity map generation module generates the left image disparity map based on belief propagation based algorithm.

Preferably, each of the intermediate-view generation module includes:

a right image disparity map generation unit for generating a rough right image disparity map by using the left image disparity map;

an occluded region compensation unit for generating a right image disparity map by removing occluded regions from the rough right image disparity map; and

an intermediate-view generation unit for generating the intermediate-view pixel data from the different view points by using the right image disparity map generated by the occluded region compensation unit.

Preferably, the multi-view three-dimensional image generation module generates the multi-view three-dimensional image pixel data by interweaving the intermediate-view pixel data from the different view points.

In accordance with another aspect of the present invention, there is provided a fast multi-view three-dimensional image synthesis method, including:

generating a left image disparity map by using left and right image pixel data;

generating intermediate-view pixel data from different view points by using the left and right image pixel data and the left image disparity map; and

generating multi-view three-dimensional image pixel data by using the left image pixel data, the right image pixel data and intermediate-view pixel data.

Preferably, said generating the intermediate-view pixel data includes:

initializing the intermediate-view pixel data;

determining a first intermediate-view pixel data mapped from the left image pixel data by using the left image disparity map;

determining a right image disparity map mapped from the left image pixel data by using the left image disparity map;

determining a second intermediate-view pixel data mapped from the right image pixel data by using the right image disparity map;

determining whether a desired intermediate-view is near to the left image pixel data or near to the right image pixel data; and

combining the first and second intermediate-view pixel data to generate the intermediate-view pixel data.

Preferably, said determining the right image disparity includes:

initializing the right image disparity map;

determining pixel values of the right image disparity map mapped from the left image disparity map by using the left image disparity map; and

compensating an occluded region of the right image disparity map by using pixel values of pixels neighboring pixels whose pixel values have been determined.

Preferably, said compensating the occluded region includes:

storing a forward neighbor pixel value of a pixel forwardly neighboring a pixel whose pixel value has been determined;

storing a backward neighbor pixel value of a pixel backwardly neighboring a pixel whose pixel value has been determined;

comparing the forward and backward neighbor pixel value;

selecting a smaller pixel value between the forward and backward neighbor pixel values; and

filling a pixel value of a pixel in the occluded region with the selected pixel value.

Preferably, said generating the intermediate-view pixel data from the different viewpoints is performed in parallel.

According to the present invention, the multi-view 3D image synthesis apparatus can perform a fast multi-view 3D image synthesis via linear parallel processing, and also can be implemented with a small-sized chip. Further, multi-view 3D images having a low error rate can be generated.

The present invention can be competitively applied to not only autostereoscopic 3D TV displays but also various autostereoscopic 3D displays, e.g., autostereoscopic 3D mobile phone displays, autostereoscopic 3D medical instruments displays and the like, due to the high-speed and high-quality multi-view 3D image synthesis thereof.

### BRIEF DESCRIPTION OF THE DRAWINGS

FIG. 1 illustrates an explanatory view of stereo image matching;

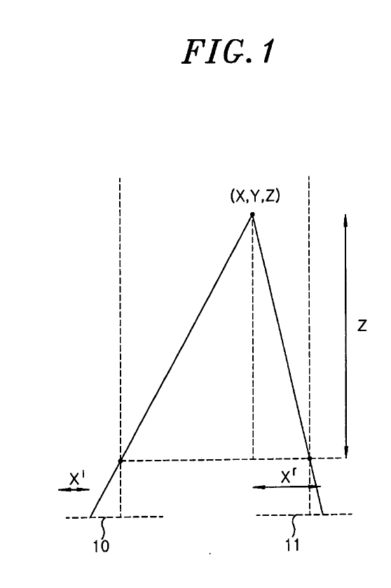

FIG. 2 illustrates an explanatory view of generating an intermediate-view in accordance with an embodiment of the present invention;

FIG. 3 illustrates a block diagram of a fast multi-view 3D image synthesis apparatus in accordance with the embodiment of the present invention;

FIG. 4 illustrates a parallel processing mechanism in the intermediate-view image generation unit of FIG. 3;

FIG. 5 illustrates a flowchart of intermediate-view generation procedure performed in the intermediate-view image generation unit shown in FIG. 3;

FIG. 6 illustrates a flowchart of right image disparity map d^{RL} generation procedure performed in the intermediate-view generation module in FIG. 3;

FIG. 7 illustrates a flowchart of occluded region compensation procedure in FIG. 6;

FIG. 8 illustrates a flowchart of multi-view 3D image generation procedure performed in the multi-view 3D image generation module in FIG. 3; and

FIG. 9 illustrates a block diagram of a parallel processing mechanism for a fast multi-view image synthesis using the apparatus in FIG. 3.

### DETAILED DESCRIPTION OF THE EMBODIMENTS

Hereinafter, an embodiment of the present invention will be described in detail with reference to the accompanying drawings, which form a part hereof.

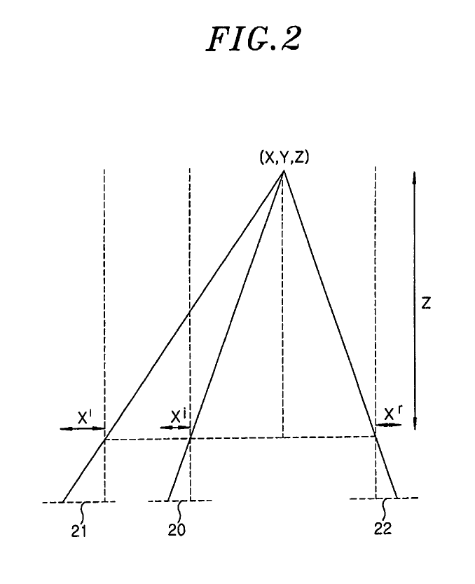

FIG. 2 illustrates an explanatory view of generating an intermediate-view in accordance with an embodiment of the present invention. In FIG. 2, an intermediate-view image 20 is a re-projected image from a left image 21 and a right image 22.

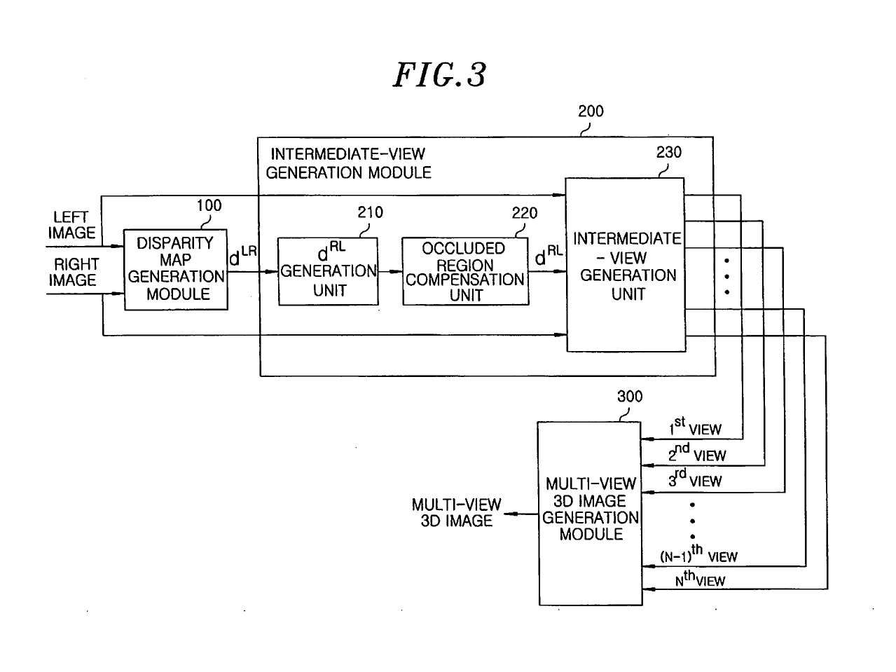

FIG. 3 illustrates a block diagram of a fast multi-view 3D image synthesis apparatus in accordance with the embodiment of the present invention. As shown in FIG. 3, a fast multi-view 3D image synthesis apparatus of this embodiment includes a disparity map generation module 100, an intermediate-view image generation module 200 and a multi-view 3D image generation module 300.

The disparity map generation module 100 receives left and right images to produce a left image disparity map d^{LR}. The intermediate-view image generation module 200 receives the left image disparity map d^{LR} from the disparity map generation module 100 and the left and right images to produce intermediate-view images from different viewpoints, i.e., a 1^{st} to N^{th} intermediate-view images, wherein N is an integer. The multi-view 3D image generation module 300 receives the 1^{st} to N^{th} intermediate-view images from the intermediate-view image generation module 200 to produce a multi-view 3D image for, e.g., autostereoscopic 3D TV displays, which gives 3D perception to viewers.

As shown in FIG. 3, the intermediate-view image generation module 200 includes a right image disparity map (d^{RL}) generation unit 210, an occluded region compensation unit 220 and an intermediate-view image generation unit 230. The right image disparity map generation unit 210 receives the left image disparity map d^{LR} from the disparity map generation module 100 to produce a rough right image disparity map having therein occluded regions. The occluded region compensation unit 220 receives the rough right image disparity map from the right image disparity map generation unit 210 and removes the occluded regions therefrom to produce a precise right image disparity map d^{RL}. The intermediate-view image generation unit 230 receives the precise right image disparity map d^{RL} from the occluded region compensation unit 220 and the left and right images to produce the 1^{st} to N^{th} intermediate-view images from different viewpoints.

The multi-view 3D image generation module 300 receives the 1^{st} to N^{th} intermediate-view images from the intermediate-view image generation unit 230 and calculates multi-view image pixel data to produce the multi-view 3D image.

The disparity map generation module 100, the intermediate-view image generation module 200 and the multi-view 3D image generation module 300 repeatedly perform the above-described processes by epipolar line basis to complete the multi-view 3D image.

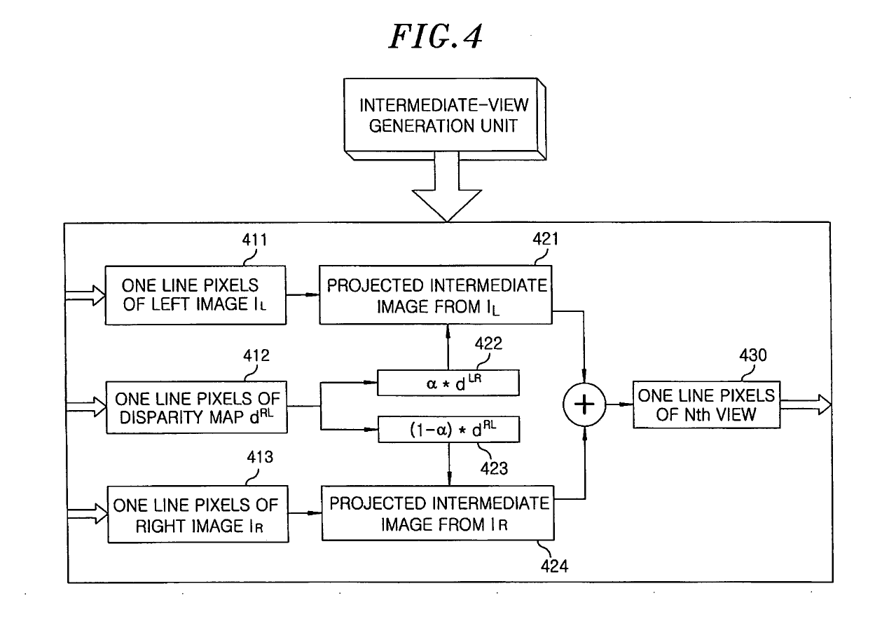

FIG. 4 illustrates a parallel processing mechanism in the intermediate-view image generation unit 230 of FIG. 3.

Referring to FIG. 4, the input data of the intermediate-view image generation unit 230 includes one line pixel data 411 of left image I_{L}, one line pixel data 413 of right image I_{R} on the same epipolar line of a pair of images and one line pixel data 412 of right image disparity d^{RL} for the stereo image pair. The intermediate data of the intermediate-view image generation unit 230 includes reprojected intermediate image 421 from the left image I_{L}, reprojected intermediate image 424 from the right image I_{R}. Further, reference numeral 422 indicates multiplication of the left image disparity d^{LR} and a coefficient α(0<α<1), which represents a relative position of the intermediate image between the left and right image, and reference numeral 423 indicates multiplication of the right image disparity d^{RL} and a coefficient 1−α(0<α<1), which also represents a relative position of the intermediate image between the left and right image. The intermediate image 421 is projected from one line pixel data 411 of the left image I_{L} by using α*d^{LR}, and the intermediate image 424 is projected from one line pixel data 413 of the right image 413 by using (1−α)*d^{RL}. The output data of the intermediate-view image generation unit 230 includes one line pixel data 430 of the N^{th} intermediate-view. The one line pixel data 430 of the N^{th} intermediate-view is produced by combining the reprojected intermediate image 421 from the left image pixel data 411 and the reprojected intermediate image 424 from the right image pixel data 413.

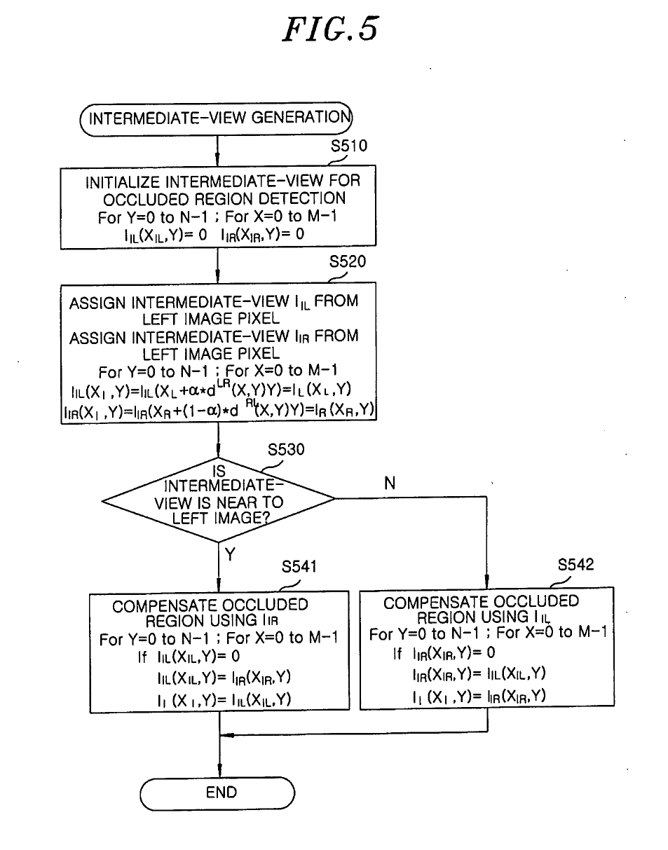

FIG. 5 illustrates a flowchart of intermediate-view generation procedure performed in the intermediate-view image generation unit 230.

Referring to FIG. 5, initial values of reprojected intermediate images I_{L}(X_{IL},Y) and I_{R}(X_{IR},Y) from the left image and from the right image, respectively, are as in Equation 1 (step S510):

For Y=0 to N−1;

For X=0 to M−1;

I_{IL}(X,Y)=0;

I_{IR}(X,Y)=0, Equation 1

wherein M is a width of the image, N is the number of viewpoints, and (X,Y) is a plane coordinate in the reprojected intermediate image.

The initial values are given for occluded region detection (steps S541 and S542). Occluded region occurs when reprojected image from left to intermediate or from right to intermediate has no information. The region occluded in the original left image is exposed in the reprojected intermediate image, because viewpoints therebetween are different. In order to detect the occluded region, the initial values of I_{L}(X_{IL},Y) and I_{R}(X_{IR},Y) are set to 0. Accordingly, by projecting from the left image to the intermediate image and from the right image to the intermediate image, a point in unoccluded region may differ from a point in the occluded region by a pixel value thereof. The intermediate images I_{IL} and I_{IR} projected from the left image I_{L} and the right image I_{R}, respectively, are assigned with intensity values as in Equation 2 (step S520):

For Y=0 to N−1;

For X=0 to M−1;

I_{IL}(X_{I},Y)=I_{IL}(X_{L}+α*d^{LR}(X,Y),Y)=I_{L}(X_{L},Y);

I_{IR}(X_{I},Y)=I_{IR}(X_{R}+(1−α)*d^{RL}(X,Y)Y)=I_{R}(X_{R},Y) Equation 2

wherein α is in a range 0<α<1, α and 1−α stand for normalized relative distances of the desired intermediate images I_{IL} and I_{IR} from the left and right images I_{L} and I_{R} respectively, d^{LR} is the disparity map from the left image I_{L} to the right image I_{R}, and d^{RL} is the disparity map from the right image I_{R} to the left image I_{L}.

If α=0 and α=1 indicate positions of the left and right images, respectively, 0<α<1 indicates a valid position of an intermediate image. In order to generate an intermediate image, a disparity with respect to a desired intermediate position is required to be assigned. This process is performed by projecting the disparity maps d^{LR} and d^{RL} onto the intermediate image. For a position (X_{L},Y) on the left image, the projected position in the intermediate image is (X_{L}+α*d^{LR}(X,Y),Y) For a position (X_{R},Y) on the right image, the projected position in the intermediate image is (X_{R}+(1−α)*d^{RL}(X,Y),Y). For each position (X_{I},Y) on the intermediate image, two corresponding positions (X_{L},Y) on the left image and (X_{R},Y) on the right image can be easily found through the two disparity maps d^{LR} and d^{RL}. For a position (X_{I},Y) on the intermediate images I_{IL} and I_{R}, virtual views can be synthesized by assigning the intensity values I_{IL}(X_{I},Y)=I_{IL}(X_{L}+α*d^{LR} (X,Y),Y)=I_{L}(X_{L},Y) and I_{IR}(X_{I},Y)=I_{IR}(X_{R}+(1−α)*d^{RL} (X,Y),Y)=I_{R}(X_{R},Y) (step S520).

Referring to FIG. 5, it is determined whether a final desired intermediate image is near to the left image (step S530).

According to the determination result in the step S530, compensation of the occluded region is performed by using Equation 3 or 4:

For Y=0 to N−1;

For X=0 to M−1;

If I_{IL}(X_{IL},Y)=0

I_{IL}(X_{IL},Y)=I_{IR}(X_{IR},Y)

I_{I}(X_{I},Y)=I_{IL}(X_{IL},Y), Equation 3

For Y=0 to N−1;

For X=0 to M−1;

If I_{IR}(X_{IR},Y)=0

I_{IR}(X_{IR},Y)=I_{IL}(X_{IL},Y)

I_{I}(I_{I},Y)=I_{IR}(X_{IR},Y) Equation 4

wherein (X_{IL},Y) stands for the occluded region of the intermediate image I_{IL} when I_{IL}(X_{IL},Y)=0, and (X_{IR},Y) stands for the occluded region of the intermediate image I_{IR} when I_{IR}(X_{IR},Y)=0.

Referencing back to FIG. 5, if it is determined in the step S530 that the final desired intermediate image I_{I} is near to left image I_{L}, the intermediate image I_{IP} is used for compensating the occluded region of the intermediate image I_{IL} (step S541). Meanwhile, if it is determined in the step S530 that the final desired intermediate image is near to right image I_{R}, the intermediate image I_{IL} is used for compensating the occluded region of the intermediate image I_{IR} (step S542). Through the compensation, I_{IR}(X_{IR},Y) is set as I_{IL}(X_{IL},Y) and the final desired intermediate image I_{I} is assigned with I_{IL}(X_{IL},Y) in the step S541, or, I_{IL}(X_{IL},Y) is set as I_{IR}(X_{IR},Y) and the final desired intermediate image I_{I} is assigned with I_{IR}(X_{IR},Y) in the step S542, as in Equation 3 or 4.

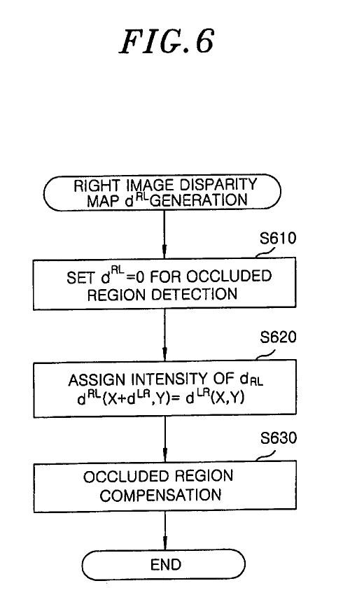

FIG. 6 illustrates a flowchart of right image disparity map d^{RL} generation procedure performed in the intermediate-view generation module 200. As described above, d^{RL} is the disparity map from the right image I_{R} to the left image I_{L}, and d^{LR} is the disparity map from the left image I_{L} to the right image I_{R}. The disparity map generation module 100 produces the disparity map d^{LR} only. However, in the intermediate-view generation procedure performed in the intermediate-view generation module 200, the disparity map d^{RL} is also needed. Thus, the intermediate-view generation module 200 calculates the disparity map d^{RL} by mapping point from d^{RL} to d^{LR}.

An initial value of the disparity map d^{RL} (X,Y) is set as in Equation 5 for the occluded region detection (step S610):

For Y=0 to N−1;

For X=0 to M−1;

d^{RL}(X,Y)=0, Equation 5

wherein d_{RL} is the disparity map from the right image I_{R} to the left image I_{L}, and (X,Y) is the plane coordinate in the disparity map.

The occluded region occurs when the reprojected disparity map d^{RL} d^{LR} has no information. The region occluded in the original disparity map d^{LR} is exposed in the reprojected disparity map d^{RL} because the viewpoints therebetween are different. In order to detect the occluded region, the initial value of the reprojected disparity map d^{RL} is set to 0. Thus, after projecting (mapping) from d^{LR} to d^{RL}, points in the unoccluded region and in the occluded region may differ by pixel values thereof.

The intensity value of the disparity map d^{RL} is assigned by projecting (mapping) from the left image I_{L} and the right image I_{R} (step S620) as in Equation 6:

For Y=0 to N−1;

For X=0 to M−1;

d^{RL}(X+d^{LR},Y)=d^{LR}(X,Y), Equation 6

wherein d^{LR} is the disparity map from the left image I_{L} to the right image I_{R}, and d^{RL} is the disparity map from the right image I_{R} to the left image I_{L}.

In order to generate the disparity map d^{RL}, the intensity value with respect to the original disparity map d^{LR} location is required to be assigned. This process is performed by projecting the disparity map d^{LR} onto the disparity map d^{RL}. For a position (X,Y) on the disparity map d^{LR}, the projected position on the disparity map d^{RL} is (X+d^{LR},Y). For each position (X+d^{LR},Y) on the disparity map d^{RL}, the corresponding position (X,Y) on the disparity map d^{LR} can be easily found through the disparity map d^{LR}. For a position (X+d^{LR},Y) on the disparity map d^{RL}, the intensity value d^{LR}(X,Y) is assigned in the step S620 to synthesize the virtual view.

After the step S620, though the disparity map d^{RL} is synthesized by assigning the intensity value as in Equation 6, the occluded region of the disparity map d^{RL} still exists. To solve this problem, the occluded region is compensated by neighbor pixel values (step S630). When the occluded region of the disparity map d^{RL} has been compensated, the generation of the disparity map d^{RL} is finished. The compensation of the occluded region compensation will be described later.

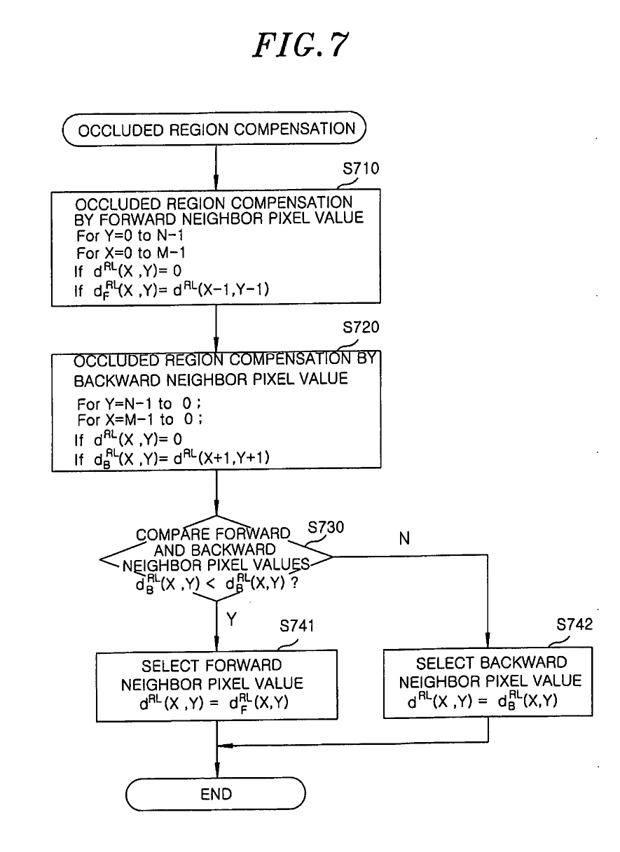

FIG. 7 illustrates a flowchart of occluded region compensation procedure in FIG. 6. In the step S620 in FIG. 6, the disparity map d^{RL} having therein the occluded region is synthesized. In order to compensate the occluded region in d^{RL}, forward and backward neighbor pixel values of the occluded region are used. Here, conflicts can occur if both of the forward and backward neighbor pixel values are in the occluded region. Hence, by comparing the forward and backward neighbor pixel values, the smaller one among the neighbor pixel values is used.

Referencing to FIG. 7, the intensity value of the occluded region of d^{RL} is filled with the forward neighbor pixel value as in Equation 7 (step S710):

For Y=0 to N−1;

For X=0 to M−1;

If d^{RL}(X,Y)=0

d_{F}^{RL}(X,Y)=d^{RL}(X−1,Y−1), Equation 7

wherein d^{RL} is the disparity map from the right image I_{R} to the left image I_{L}, (X,Y) stands for the occluded region of the disparity map d^{RL} when d^{RL} (X,Y)=0, (X−1,Y−1) stands for the forward neighbor pixel value of the occluded region, and d_{F}^{RL} indicating the intensity value of the occluded region after compensation is set as the forward neighbor pixel value.

Referring to FIG. 7, the intensity value of the occluded region of d^{RL} is filled with the backward neighbor pixel value as in Equation 8 (step S720):

For Y=0 to N−1;

For X=0 to M−1;

If d^{RL}(X,Y)=0

d_{B}^{RL}(X,Y)=d^{RL}(X+1,Y+1), Equation 8

where d^{RL} is the disparity map from the right image I_{R} to the left image I_{L}, (X,Y) stands for the occluded region of the disparity map d^{RL} when d^{RL}(X,Y)=0, (X+1,Y+1) stands for the backward neighbor pixel value of the occluded region, and d_{B}^{RL} indicating the intensity value of the occluded region after compensation is set as the backward neighbor pixel value.

The intensity values of the occluded region d_{F}^{RL} and d_{B}^{RL} are compared as in Equation 9 (step S730):

$${d}^{RL} ( X , Y ) = \{ \begin{matrix}{d}_{F}^{RL} ( X , Y ) , & if {d}_{F}^{RL} ( X , Y ) < {d}_{B}^{RL} ( X , Y ) \\ {d}_{B}^{RL} ( X , Y ) , & i f {d}_{F}^{RL} ( X , Y ) > {d}_{B}^{RL} ( X , Y ) .\end{matrix} \qquad Equation 9$$

If d_{F}^{RL}(X,Y)<d_{B}^{RL}(X,Y), the forward neighbor pixel value d_{F}^{RL} is selected to compensate the occluded region of d^{RL}(X,Y) (step S741). If d_{F}^{RL}(X,Y)>d_{B}^{RL}(X,Y), the backward neighbor pixel value d_{B}^{RL} is selected to compensate the occluded region d^{RL}(X,Y) (step S742).

The intensity value of the occluded region d^{RL}(X,Y) is determined through the steps S730, S741 and S742. The occluded region of d^{RL} (X,Y) is a background object in the stereo image pairs. Since a disparity value of a background object is always smaller than that of a foreground object, the disparity value of the occluded region of d^{RL} (X,Y) is given with the smaller value between forward and backward neighbor pixel values.

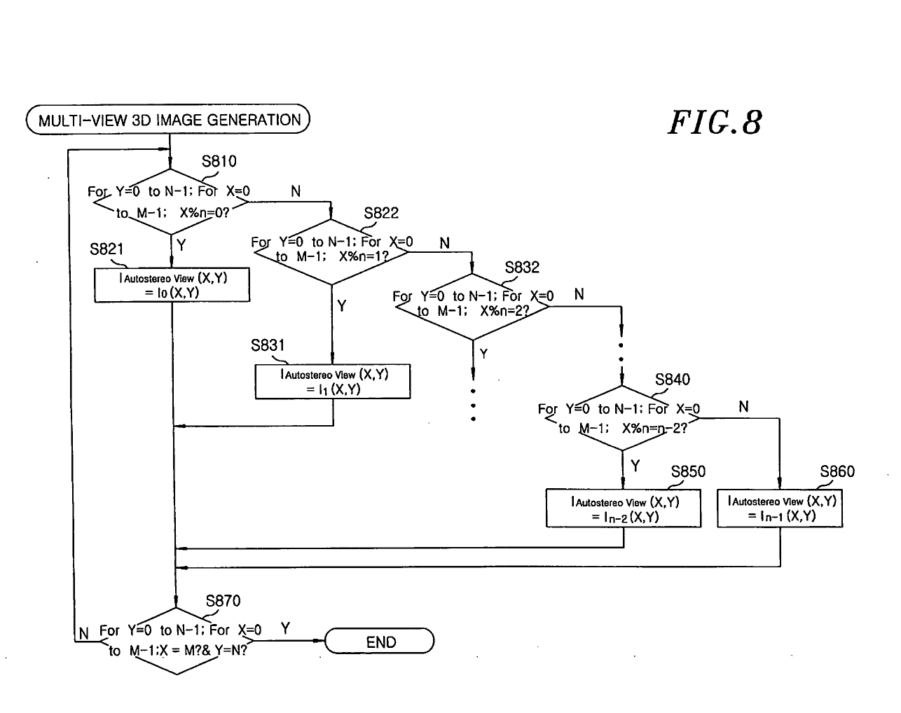

FIG. 8 illustrates a flowchart of multi-view 3D image generation procedure performed in the multi-view 3D image generation module 300 in FIG. 3.

An autostereoscopic multi-view display with n views requires n−2 intermediate-view from various viewpoints between original left and right images. If the intermediate-view synthesis in FIG. 5 is applied, intermediate-views from various viewpoints can be created.

A multi-view 3D image for the autostereoscopic 3D TV displays is made by interweaving the columns from n views of various viewpoints. The n views are arranged so that the left eye is allowed to see strips from left eye images only and the right eye is allowed to see strips from right eye images only, which gives a viewer a 3D perception (depth of a 3D scene).

Individual images from various viewpoints are interleaved as in Equation 10 to form a multi-view 3D image for the autostereoscopic 3D TV displays:

$$For Y = 0 to N - 1 ; \\ For X = 0 to M - 1 ; \\ \{ \begin{matrix}{I}_{AutostereoView} ( X , Y ) = {I}_{0} ( X , Y ) , & if X \% n = 0 \\ {I}_{AutostereoView} ( X , Y ) = {I}_{1} ( X , Y ) , & if X \% n = 1 \\ {I}_{AutostereoView} ( X , Y ) = {I}_{2} ( X , Y ) , & if X \% n = 2 \\ ⋮ & \\ {I}_{AutostereoView} ( X , Y ) = {I}_{n - 2} ( X , Y ) , & if X \% n = n - 2 \\ {I}_{AutostereoView} ( X , Y ) = {I}_{n - 1} ( X , Y ) , & if X \% n = n - 1\end{matrix} \qquad Equation 10$$

wherein I_{AutostereoView} stands for the pixel value of a multi-view 3D image, I₀ to Iₙ₋₁ stand for the pixel values of n sub-images from various viewpoints to form a multi-view 3D image for the autostereoscopic 3D TV displays. To be specific, I₀ is the original left image, Iₙ₋₁ is the original right image and Iₙ₋₂ to stand for n−2 intermediate-views from various viewpoints between the original left and right images. In Equation 10, X % n represents a remainder of division of the sub-images n by the horizontal axis X in steps S810 to S860,

Referring to FIG. 8, in order to form a multi-view 3D image for the autostereoscopic 3D TV displays, column pixels of n views from various viewpoints are interleaved in sequence from I₀ to Iₙ₋₁. Multi-view 3D image content observed by the viewer depends upon a position of the viewer with respect to the autostereoscopic 3D TV displays screen. Due to the autostereoscopic 3D TV displays screen (lenticular or Parallax barrier), the left eye of the viewer receives a column pixels that is different from what the right eye thereof receives, which gives the viewer a 3D perception (depth of a 3D scene).

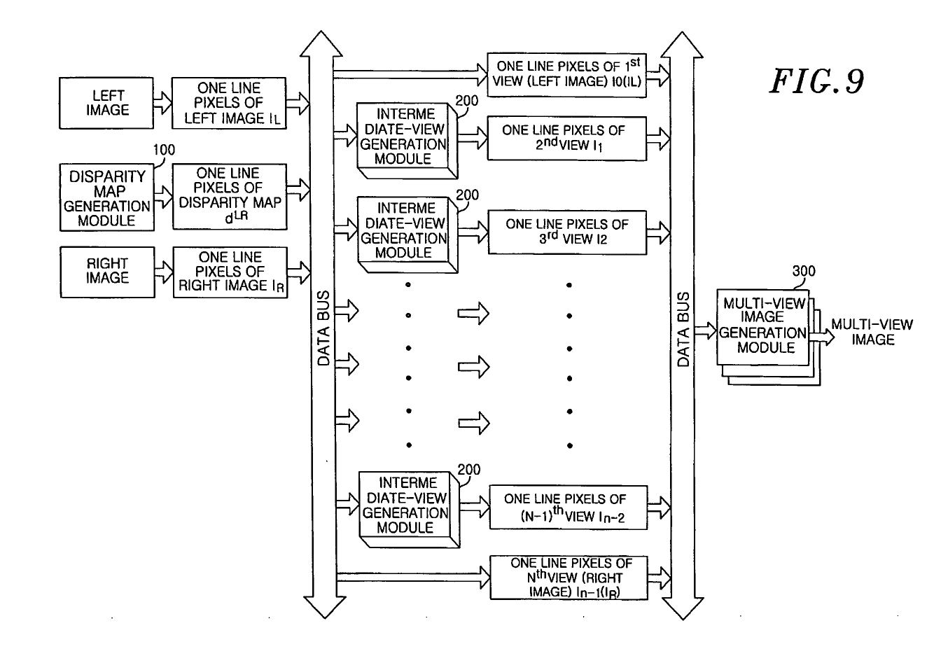

FIG. 9 illustrates a block diagram of a parallel processing mechanism for a fast multi-view image synthesis using the apparatus in FIG. 3. As shown in FIG. 9, the disparity map generation module 100 outputs one line pixel value of a left image disparity map d^{LR}. Further, one line pixel values of the left and right images at the same time are also produced. For parallel processing to generate 1^{st to N}^{th} views from various viewpoints, the number of the intermediate-view generation module 200 is N−2. After receiving one line pixel values of the left image, the right image and the left image disparity map d^{LR}, each of the N−2 intermediate-view generation modules outputs one line pixel value from a viewpoint thereof. Here, the 1^{st} intermediate-view is the left image and the N^{th} intermediate-view is the right image.

The multi-view 3D image generation module 300 receives one line pixel values of the 1^{st} to N^{th} intermediate-views from the intermediate-view generation modules 200, and outputs a multi-view 3D image for autostereoscopic 3D TV displays to give user a 3D perception. Since the respective 1^{st} to N^{th} intermediate-views are produced line by line, the fast multi-view image synthesis method using disparity map can be processed in parallel. That is, the left and right images can be synthesized a multi-view 3D image for the autostereoscopic 3D TV displays in parallel.

While the invention has been shown and described with respect to the embodiments, it will be understood by those skilled in the art that various changes and modification may be made without departing from the scope of the invention as defined in the following claims.

What is claimed is:

1. A fast multi-view three-dimensional image synthesis apparatus, comprising:
a disparity map generation module for generating a left image disparity map by using left and right image pixel data;
intermediate-view generation modules for generating intermediate-view pixel data from different view points by using the left and right image pixel data and the left image disparity map; and
a multi-view three-dimensional image generation module for generating multi-view three-dimensional image pixel data by using the left image pixel data, the right image pixel data and intermediate-view pixel data.

2. The apparatus of claim 1, wherein the left and right image pixel data are on an identical epipolar line.

3. The apparatus of claim 1, wherein the disparity map generation module generates the left image disparity map based on belief propagation based algorithm.

4. The apparatus of claim 1, wherein each of the intermediate-view generation module includes:
a right image disparity map generation unit for generating a rough right image disparity map by using the left image disparity map;
an occluded region compensation unit for generating a right image disparity map by removing occluded regions from the rough right image disparity map; and
an intermediate-view generation unit for generating the intermediate-view pixel data from the different view points by using the right image disparity map generated by the occluded region compensation unit.

5. The apparatus of claim 1, wherein the multi-view three-dimensional image generation module generates the multi-view three-dimensional image pixel data by interweaving the intermediate-view pixel data from the different view points.

6. A fast multi-view three-dimensional image synthesis method, comprising:
generating a left image disparity map by using left and right image pixel data;
generating intermediate-view pixel data from different view points by using the left and right image pixel data and the left image disparity map; and
generating multi-view three-dimensional image pixel data by using the left image pixel data, the right image pixel data and intermediate-view pixel data.

7. The method of claim 6, wherein said generating the intermediate-view pixel data includes:
initializing the intermediate-view pixel data;
determining a first intermediate-view pixel data mapped from the left image pixel data by using the left image disparity map;
determining a right image disparity map mapped from the left image pixel data by using the left image disparity map;
determining a second intermediate-view pixel data mapped from the right image pixel data by using the right image disparity map;
determining whether a desired intermediate-view is near to the left image pixel data or near to the right image pixel data; and
combining the first and second intermediate-view pixel data to generate the intermediate-view pixel data.

8. The method of claim 7, wherein said determining the right image disparity includes:
initializing the right image disparity map;
determining pixel values of the right image disparity map mapped from the left image disparity map by using the left image disparity map; and
compensating an occluded region of the right image disparity map by using pixel values of pixels neighboring pixels whose pixel values have been determined.

9. The method of claim 8, wherein said compensating the occluded region includes:
storing a forward neighbor pixel value of a pixel forwardly neighboring a pixel whose pixel value has been determined;
storing a backward neighbor pixel value of a pixel backwardly neighboring a pixel whose pixel value has been determined;
comparing the forward and backward neighbor pixel value;
selecting a smaller pixel value between the forward and backward neighbor pixel values; and
filling a pixel value of a pixel in the occluded region with the selected pixel value.

10. The method of claim 6, wherein said generating the intermediate-view pixel data from the different viewpoints is performed in parallel.
